(19) United States
(12) Patent Application Publication
(10) Pub. No.: US 2026/0062195 A1
(43) Pub. Date: Mar. 5, 2026

(54) LIQUID COOLING VACUUM FLASK

(71) Applicant: Fridababy, LLC, Miami, FL (US)

(72) Inventors: Ed ABANTE, Miami, FL (US); Greg HURLEY, Boca Raton, FL (US); Adi ORUCEVIC, Miami, FL (US); Chelsea HIRSCHHORN, Miami Beach, FL (US)

(21) Appl. No.: 19/239,150

(22) Filed: Jun. 16, 2025

Related U.S. Application Data
(60) Provisional application No. 63/689,407, filed on Aug. 30, 2024.

(51) Int. Cl. B65D 81/38; A61J 9/06; B65D 81/18

(52) U.S. Cl. CPC B65D 81/3841; A61J 9/06; B65D 81/18; B65D 81/3839; A61J 2200/44

(57) ABSTRACT

A vacuum flask including an outer shell, a cage removably coupled with the outer shell, and a bottom cover coupled to the cage. The bottom cover and outer shell enclose the internal cage when the cage is coupled with the outer shell. The cage is configured to receive a vessel for holding a liquid, an infant bottle, or one or more milk bags. In some examples, the vacuum flask may be used to store, one of a vessel (e.g., container) specified for storing a liquid, an infant bottle, or milk storage bags.

### CROSS-REFERENCE TO RELATED APPLICATION

The present application claims the benefit of U.S. Provisional Patent Application No. 63/689,407, filed on Aug. 30, 2024, and titled “Liquid cooling vacuum flask,” the disclosure of which is expressly incorporated by reference in its entirety.

### FIELD OF THE DISCLOSURE

Aspects of the present disclosure generally relate to vacuum flasks, and more specifically to vacuum flasks for cooling liquids.

### BACKGROUND

A vacuum flask is an insulated container designed to maintain the temperature of its contents over extended periods, either by keeping liquids hot or cold. The core design of a vacuum flask consists of two containers, one nested within the other, with a vacuum separating them. The inner container, typically made of glass or stainless steel, holds the liquid, while the outer container, often constructed from metal or plastic, provides structural support and protection. The vacuum between these two containers acts as an effective insulator, minimizing heat transfer by conduction and convection. Additionally, the inner container is usually coated with a reflective material to further reduce heat loss through radiation. A tightly sealed cover, such as a lid, is used to prevent heat exchange through a top or bottom of the flask. Some designs incorporate a stopper or spout to facilitate pouring while minimizing exposure to external temperatures.

### SUMMARY

The present disclosure relates broadly to a vacuum flask for maintaining the temperature, or cooling, its contents. The vacuum flask includes an outer shell, a cage removably coupled with the outer shell, and a bottom cover coupled to the cage. The cage is configured to receive a vessel for holding a liquid, an infant bottle, or one or more milk bags. The bottom cover and outer shell enclose the internal cage when the cage is coupled with the outer shell. In some examples, the vacuum flask may be used to store, one of a vessel (e.g., container) specified for storing a liquid, an infant bottle, or milk storage bags. The cage may retain items positioned within it when the outer cover is attached to the cage, or when they are detached. For example, the cage may hold various items in place, so they do not move or roll away, while a user is using the vacuum flask. Such items include a vessel holding a liquid and a puck filled with freezable liquid to cool the liquid in the vessel.

In another aspect of the present disclosure, the cage includes arms that extend upward, and the arms define slits on the side of the cage. A portion of a flexible milk bag may be positioned in these slits and held in place, in order to hold milk bags open, facilitating easy and mess-free pouring.

In another aspect of the present disclosure, the disclosure relates to a vacuum flask including an outer shell having a cylindrical shape with a first and second end, and the second end includes an opening, a bottom cover, a cage coupled to the bottom cover and configured to removably couple to the outer shell, a vessel disposed in the cage, wherein the vessel is configured to receive a liquid, and a lid configured to couple to the vessel, wherein the lid is adapted to receive a freezable liquid.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is an exploded perspective front view of a vacuum flack, in accordance with various aspects of the present disclosure.

FIG. 2A is a top view of the vacuum flask of FIG. 1, in accordance with various aspects of the present disclosure.

FIG. 2B a sectioned view of the vacuum flask of FIG. 1 through line A-A shown in FIG. 2A, in accordance with various aspects of the present disclosure.

FIG. 3A is a front view of the vacuum flask of FIG. 1, in accordance with various aspects of the present disclosure.

FIG. 3B is a bottom view of the vacuum flask of FIG. 1, in accordance with various aspects of the present disclosure.

FIG. 4 is a front view of the cage and bottom cover of the vacuum flask of FIG. 1. is a perspective side view of the vacuum flask of FIG. 1, in accordance with various aspects of the present disclosure.

FIG. 5A is a perspective front view of a milk bag and a cage as shown in FIG. 1, in accordance with various aspects of the present disclosure.

FIG. 5B is a diagram illustrating a top-down view of a milk bag positioned within the cage, in accordance with various aspects of the present disclosure.

FIG. 5C is a side view of a milk bag positioned within the cage, in accordance with various aspects of the present disclosure.

FIG. 5D is a diagram illustrating a side view of the cage, in accordance with various aspects of the present disclosure.

FIG. 6 is a perspective view of an infant bottle and a cage, as shown in FIG. 1, in accordance with various aspects of the present disclosure

FIG. 7 is an exploded front view of the vessel of FIG. 1, in accordance with various aspects of the present disclosure.

FIG. 8 is a flow diagram illustrating a process of using a vacuum flask, in accordance with various aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts.

Based on the teachings, one skilled in the art should appreciate that the scope of the present disclosure is intended to cover any aspect of the present disclosure, whether implemented independently of or combined with any other aspect of the present disclosure. For example, an apparatus may be implemented, or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. It should be understood that any aspect of the present disclosure may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the present disclosure. Although some benefits and advantages of the preferred aspects are mentioned, the scope of the present disclosure is not intended to be limited to particular benefits, uses, or objectives. Rather, aspects of the present disclosure are intended to be broadly applicable to different technologies, system configurations, networks, and protocols, some of which are illustrated by way of example in the figures and in the following description of the preferred aspects. The detailed description and drawings are merely illustrative of the present disclosure rather than limiting, the scope of the present disclosure being defined by the appended claims and equivalents thereof.

Vacuum flasks are widely used in various applications, ranging from household use to outdoor activities. In such cases, the vacuum flask may be used to store beverages or meals, such as soup, at a certain temperature for a period of time. In medical and laboratory settings, vacuum flasks may be used for storing temperature-sensitive substances, such as vaccines, or for conducting experiments that require a stable thermal environment. Additionally, vacuum flasks may be used to keep baby bottles warm or cold during travel.

Modern vacuum flasks have evolved to include various sizes, shapes, and features to meet diverse user needs, such as integrated cups, handles, or temperature indicators, which enhance their functionality. Despite these advancements, the fundamental design of the vacuum flask has remained largely consistent. Specifically, traditional vacuum flasks are typically limited to holding a liquid substance, such as a beverage or soup, or a single container, such as a baby bottle. Conventional vacuum flasks lack the versatility to accommodate different types of containers within the flask, restricting their overall utility.

Various aspects of the present disclosure are directed to a vacuum flask (also referred to as a vacuum insulated flask) for storage and cooling of a liquid, such as milk or breast milk, throughout the day. The vacuum flask is versatile, accommodating various use cases. In some examples, the vacuum flask may be used to store, one of a vessel (e.g., container) specified for storing a liquid, an infant bottle, or milk storage bags. The vacuum flask may keep the liquid cool for an extended time period. In some examples, the vacuum flask includes an outer shell that slides over a cage having threads to secure the outer shell to the cage, and secure the cage between the outer shell and a bottom cover. The top of the outer shell may include a depression for attaching a handle base and handle, providing convenience and portability. The handle base and handle may be affixed to the top of the vacuum flask, offering an easy way to carry the flask. The cage is designed to house the vessel, an infant bottle, or milk bags (e.g., liquid bags). The cage includes slits on the sides for holding milk bags open, facilitating easy and mess-free pouring. The vessel includes a lid (e.g., cap) that may be fillable or pre-filled with a liquid, such as water, that is capable of being frozen. Additionally, a puck is included, which may be fillable or pre-filled with a liquid, such as water or a phase change material. The puck may be frozen and placed in the vacuum flask prior to use, thereby reducing the temperature of the milk or other liquid stored in the vessel, infant bottle, or milk bag. This puck may be positioned within the cage. For example, the puck may be positioned beneath the vessel, between milk bags, beneath milk bags, or beneath an infant bottle. Aspects of the present disclosure are not limited to the use of a single puck. Multiple pucks may be used in a number of different configurations. Finally, a bottom cover makes up the bottom part of the vacuum flask, providing stability and preventing slipping with an anti-slip pad.

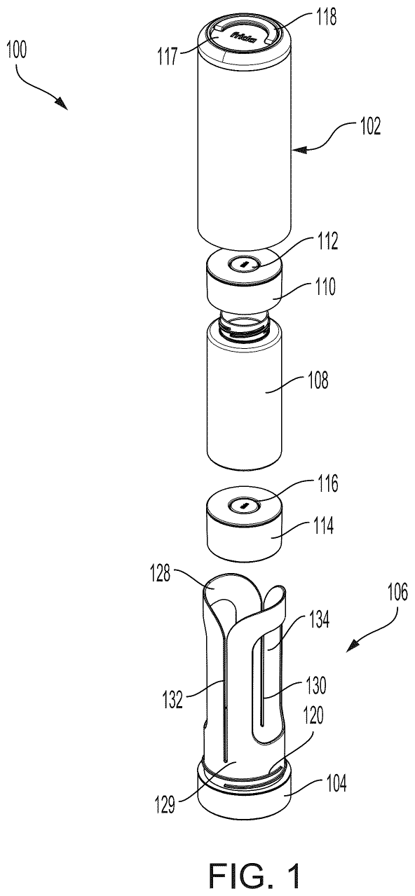

FIG. 1 illustrates an example of a vacuum flask 100, in accordance with various aspects of the present disclosure. Specifically, FIG. 1 illustrates an exploded view of the vacuum flask 100. The vacuum flask 100 includes an outer shell 102, a bottom cover 104, and a cage 106. The outer shell 102 is adapted to slide over the outside of the cage 106 and couple to the cage 106 to define an internal volume, and the bottom cover 104 is coupled to the cage 106. The bottom cover 104, together with the outer shell 102, insulate the interior volume of the vacuum flask 100. The interior of the cage 106 is configured to receive one of a vessel 108 specified for storing a liquid, a milk storage bag 208, or an infant bottle 308. The vessel 108 is sized to be retained in the cage 106, so that the vessel 108 is secured with minimal movement in relation to the outer shell 102 of the vacuum flask 100.

The outer shell 102 is cylindrically shaped with an opening on the bottom to receive the cage 106. The top outer portion of the outer shell 102 includes a depression for receiving a handle base 117, and a handle 118 that is attached to the handle base 117. The handle 118 is a semi-circular shape, and it is pivotable with respect to the outer shell 102 so that the handle may lay flat against the handle base 117 or be rotated to an upright position when it is in use. It would be recognized that other handle configurations may be provided, such as a strap or loop.

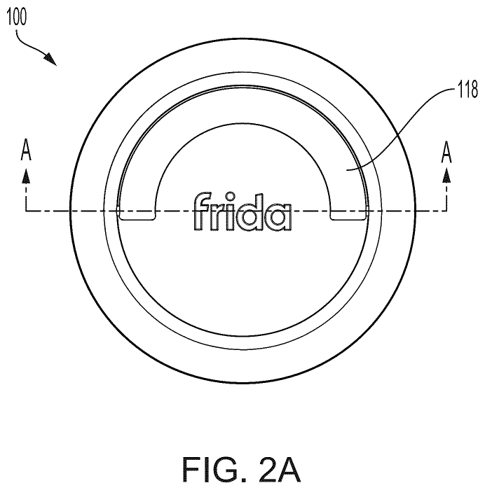

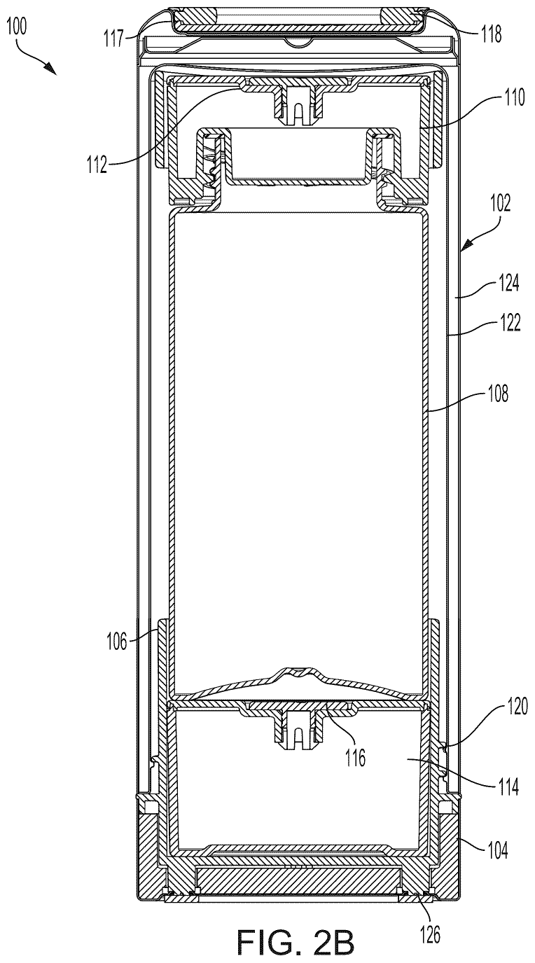

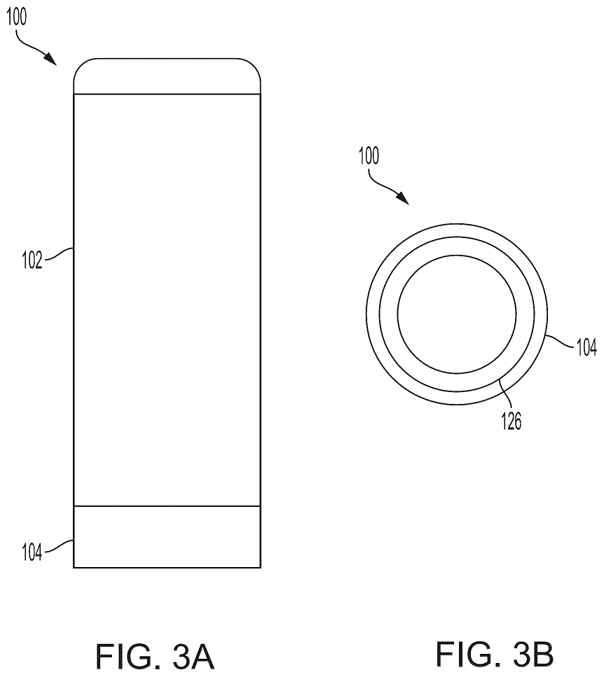

The bottom cover 104 may be coupled to the cage 106. In some examples, the bottom cover 104 may be detachably coupled to the cage 106. The bottom cover 104 may be made of metal, such as stainless steel, or other material. The bottom cover 104 may also include insulation, such as expanded polystyrene (EPS) foam or expandable foam. The cage 106 may be formed from a plastic such as high impact polystyrene (HIPS) or polypropylene (PP). Alternatively, the bottom cover 104 and cage 106 may be a unitary component. An anti-slip pad 126 may be provided on the bottom surface of the bottom cover 104. In some examples, the anti-slip pad 126 may be circular-shaped and concentric with the circular cross-sections of the outer shell 102 and bottom cover 104 (see FIGS. 2B and 3B). However, other pad configurations may alternatively be provided. Aspects of the present disclosure are not limited to the specific materials explicitly described in the specification, such as stainless steel for the bottom cover 104 or high impact polystyrene and polypropylene for the cage 106. These materials are provided as examples, and it should be understand that other suitable materials may be used. For example, in some examples, the bottom cover 104 and/or the cage 106 may be constructed from other durable and heat-resistant materials such as Acrylonitrile Butadiene Styrene (ABS), polyphenylsulfone (PPSU), nylon, or polyethylene. These materials may offer different mechanical properties, thermal performance, or cost advantages, depending on the use case or design requirements. This flexibility in material selection is consistent with other examples, which contemplate both metallic and polymeric options and the possibility of forming the bottom cover 104 and cage 106 as a unitary component. Therefore, the disclosure should be interpreted to encompass a range of material options that achieve the intended structural and functional characteristics described.

The vessel 108 includes a lid 110 that is configured to threadably couple to the vessel 108 to close a vessel aperture of the vessel 108. The lid 110 includes an interior volume to receive a freezable liquid, and the lid 110 may include a lid cap 112. The lid cap 112 is removably attached to the lid 110, so the lid 110 may be filled with a freezable liquid. In another aspect, the lid 110 may be pre-filled with a freezable liquid by a manufacturer, and the lid 110 does not include a lid cap 112. In this aspect, the lid cap 112 is a plug that is pressed in place.

A puck 114 may also be disposed within the cage 106. The puck 114 is fillable or pre-filled with a freezable liquid, and a removable puck cap 116 may be provided to seal the interior of the puck 114 to retain a freezable liquid within the interior of the puck 114. The puck 114 may be placed in the cage 106 first, prior to the vessel 110, so that the puck 114 provides a cooling effect from the bottom of the vessel 108, while the freezable liquid in the lid 114 provides a cooling effect from the top of the vessel 108. However, it would be appreciated that this arrangement of the components is not required. In some aspects, the lid 110 may be pre-filled with a freezable liquid by a manufacturer, and the lid 110 does not include a lid cap 112.

FIG. 2A is a top view of the vacuum flask 100, and FIG. 2B is a sectioned view of the vacuum flack 100 at line A-A, in accordance with various aspects of the present disclosure. The outer shell 102 includes an inner wall 122 and an outer wall 124, which is spaced apart from the inner wall 122. A vacuum is formed between the inner and outer walls 122, 124 to reduce the transfer of heat energy to or from the contents of the vacuum flask 100. The outer wall 124 may be made of metal, such as stainless steel, plastic, or other suitable materials. The inner wall 122 may be made of metal or glass. The inner wall 122 includes a threaded portion on the interior surface which is adapted to receive and couple to the threads 120 disposed on the cage 106. The threaded portion on the inner wall 122 is proximal to the opening of the outer shell 102. It would also be appreciated that other non-permanent attachment mechanisms may be used to couple the outer shell to the bottom cover, such as a friction fit, or other locking mechanisms.

The vessel 108 has a cylindrical shape and is sized to be received by a portion of the cage 106. The vessel 108 is sized to be retained in the cage 106, so that the vessel 108 is secured with minimal movement in relation to the outer shell 102 of the vacuum flask 100. Movement of the vessel 108 may be minimized in the lateral direction against the sides of the cage 106 and longitudinally against the top of the outer shell 102, to prevent additional shaking to any liquids that may be present in the vessel 108. The vessel 108 may be formed from glass or plastic, such as polypropylene. The vessel 108 may be transparent, so the contents of vessel 108 may be readily seen. The sides of the vessel 108 may include measurement numbers and/or markings to indicate the volume of liquid in the vessel 108. The measurement indicators would allow for adding or removing the desired amount of liquid from the vessel 108, such as pouring breast milk from the vessel 108 into another container, such as a milk bag or infant bottle. The lid 110 and/or puck 114 may also be formed of plastic such as acrylonitrile butadiene styrene (ABS), polypropylene, or another suitable material.

The cage 106 includes an open area to receive the vessel 108 and/or other items, such as bottles, milk bags, etc. The vessel 108 and/or the other items may be placed in the open area of the cage 106 through the top portion of the cage 106, opposite the base portion 129 of the cage 106. The cage 106 offers versatile storage options, capable of holding the vessel 108 and the puck 114 or storing an infant milk bottle or one or more milk bags. The puck 114 and/or the lid 110 may also be stored with the milk bottle or one or more milk bags to improve the thermal performance of the vacuum flask 100. The cage 106 may be used to hold milk bags open, facilitating the transfer of milk from a pumping container or to an infant bottle.

FIG. 3A illustrates a front view of the vacuum flask 100, in accordance with various aspects of the present disclosure. The outer shell 102 is coupled to the bottom cover 104 to seal the interior of the vacuum flask 100 in order to maintain the temperature of any liquids stored in the interior of the vacuum flask 100 (or cool the liquid if frozen liquid was provided in the puck 114 and in the lid 110). FIG. 3B illustrates the bottom view of the vacuum flask 104, showing the anti-slip pad 126, in accordance with various aspects of the present disclosure. The anti-slip pad 126 may be formed from silicone, rubber, or another suitable material such that the bottom cover 104 is less likely to damage a surface, and so the bottom cover 104 has an increased friction coefficient, so the vacuum flask 100 reduces sliding on a surface.

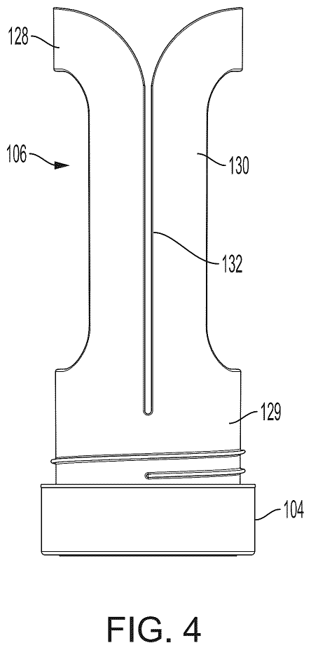

FIG. 4 illustrates the bottom cover 104 and the cage 106, in accordance with various aspects of the present disclosure. As shown in the example of FIG. 4, the cage 106 includes arms 128, 130 that extend upward from a base portion 129 of the cage 106. The base portion 129 includes threads 120 for coupling to the outer shell 102. The threads 120 may be male or female threads. Between the arms 128, 130, a generally cylindrical area is defined to receive the vessel 108 or other items. Two slits 132, 134 may be defined between the arms 128, 130, where the arms 128, 130 are proximate to each other. The arms 128, 130 are generally rigid; however, they exhibit some flexibility such that the arms 128, 130 may be partially separated to position the sides of a flexible milk bag in the slits 132, 134. The arms 128, 130 frictionally engage the portion of the flexible milk bag. A user may apply additional pressure to the arms 128, 130, such that the arms 128, 130 are able to hold the milk bag in position, even when milk is poured out of the milk bag. This provides for easier pouring and greater control. In another aspect, the arms 128, 130 flex toward each other to provide pressure against each other to secure the sides of flexible milk bags, and a user may flex the arms 128, 130 apart to position a portion of a flexible milk bag in the slits 132, 134. After a user releases the arms 128, 130, the arms 128, 130 retain the sides of the flexible milk bag in the slits 132, 134. By securing the sides of a flexible bag, it is easier to pour liquid from the flexible bag, such as into an infant bottle, and it is also easier to pour liquid into the flexible bag, such as breast milk from a breast-pump storage container. This aspect allows for easier pumping and storage of breast milk while also cooling the breast milk so it can be safely consumed at a later time. The arms 128, 130 also facilitate loading and unloading of milk bags or other containers within the cage 106.

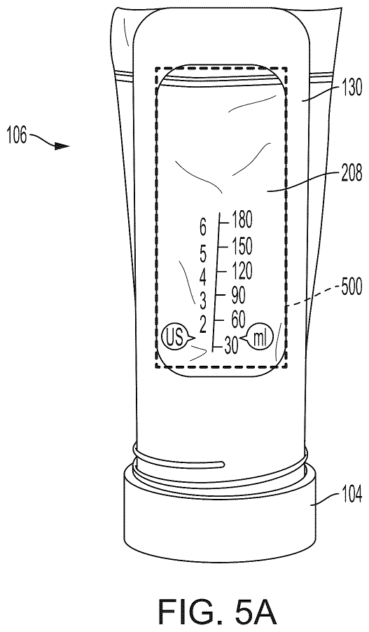

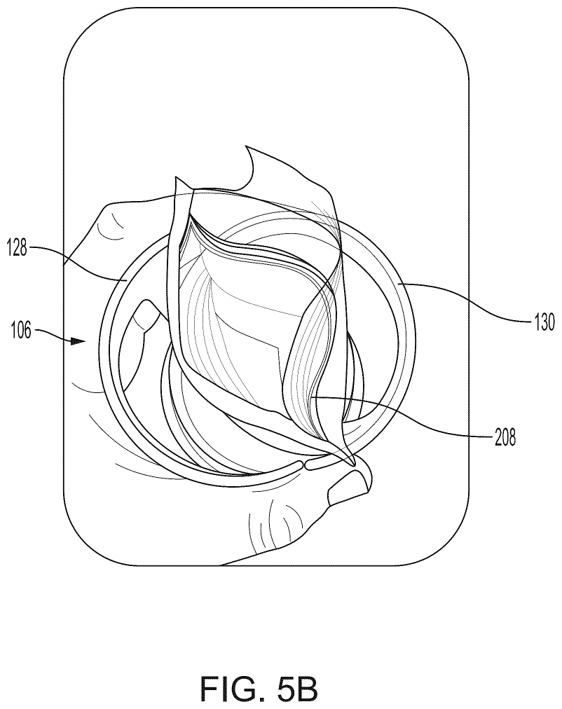

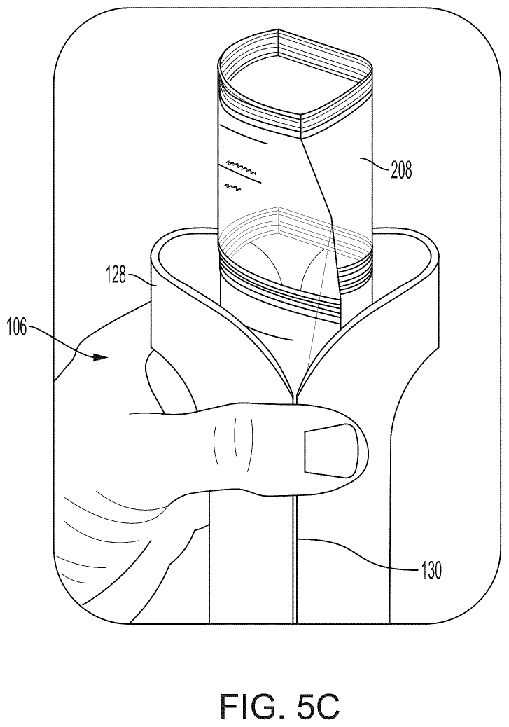

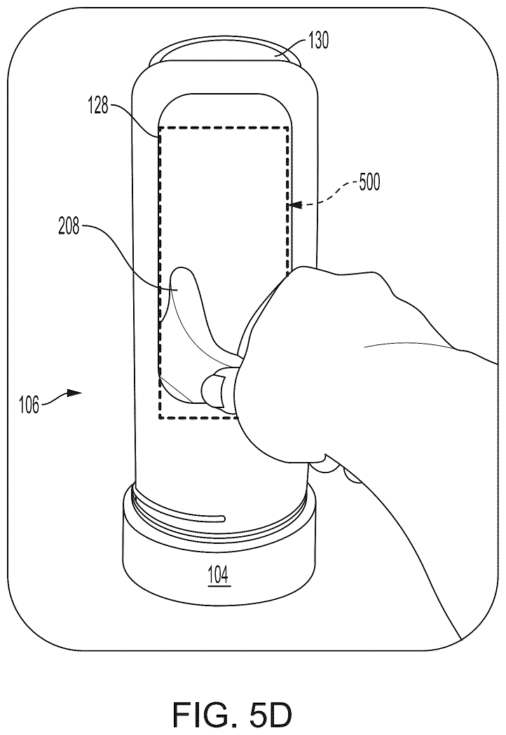

FIG. 5A is a diagram illustrating an example of a milk bag 208 retained by the cage 106, in accordance with various aspects of the present disclosure. As shown in FIG. 5A, the milk bag 208 is retained by the cage 106 such that the sides of the milk bag 200 are positioned in the slits of the cage 106. Such as the slits 132, 124 described with reference to FIG. 4. The arms 128, 130 each include a window 500, indicated by the dotted lines. Providing a cage 106 to hold the milk bag avoids the need to set the milk bag down on another surface, which risks contaminating the milk bag with germs. It would be understood that one or more pucks may be provided in the cage 106, and one or more milk bags may also be stored within the vacuum flask 100 along with the one or more pucks. The one or more pucks may be an example of the puck 114 described with reference to FIGS. 1 and 2B. In some examples, a first puck may be placed at the bottom of the cage 106, then a first liquid container (e.g., milk bag, vessel, baby bottle, etc.) may be placed on top of the first puck, then a second puck may be placed on top of the first liquid container, and then a second liquid container may be placed on top of the second puck. Additional pucks and/or containers may be used. While the milk bag 208 in FIG. 5A is shown standing upright during filling, after the bag is sealed, the bag may be positioned so it is closer to a puck 114 to keep the milk cold.

FIG. 5B is a diagram illustrating a top-down view of a milk bag 208 positioned within the cage 106, in accordance with various aspects of the present disclosure. As discussed, the cage 106 includes two arms, 128 and 130, extending vertically from the base of the cage. These arms are designed to flex slightly, allowing the milk bag 208 to be securely held in place while also permitting easy adjustment. When the user applies pressure to the sides of the cage 106 by squeezing the arms 128 and 130, the milk bag 208 opens, creating a stable opening for pouring milk or other liquid contents. This configuration ensures that the milk bag 208 remains upright and prevents accidental spills, making it easier to transfer milk from a pumping container or another storage vessel. The structural design of the cage 106 provides support to the milk bag 208, eliminating the need for external assistance to keep it open during use. Additionally, the flexible nature of the arms 128 and 130 allows for quick insertion and removal of the milk bag 208, enhancing convenience while maintaining a secure grip on the bag 208.

FIG. 5C is a side view of a milk bag 208 positioned within the cage 106, in accordance with various aspects of the present disclosure. As discussed, the cage 106 consists of two flexible arms, 128 and 130, that extend upward from the base. These arms are designed to flex outward when pressure is applied to the sides, allowing the opening of the milk bag 208 to widen for easy pouring or filling. In this view, a user is shown squeezing the cage 106, which changes a form of the arms 128 and 130, thus creating an expanded opening at the top of the milk bag 208. This design allows the user to hold the bag 208 open with one hand, providing a stable and controlled means of transferring liquid into or out of the bag 208 without requiring additional support.

The material composition of the cage 106 enables sufficient flexibility while maintaining structural integrity to support the milk bag 208. The arms 128 and 130 apply a slight inward pressure when released, which helps to securely grip the milk bag 208 and prevent it from collapsing inward. This feature ensures that the bag 208 remains upright and in position, minimizing the risk of spills or contamination. Vertical slits, such as slit 132, may be positioned at the junction of the arms to provide a guiding mechanism for the milk bag 208, ensuring easy insertion and secure placement with minimal movement. While FIG. 5C illustrates a single slit 132, the cage 106 may include two vertical slits, as each arm 128 and 130 has a “C” shape, with a slit forming at each side where the two arms 128 and 130 converge.

The tapered design of the arms 128 and 130 ensures that the milk bag remains stable even when it is partially filled, preventing accidental tipping. This configuration is particularly useful for users handling breast milk, as it facilitates a smooth and controlled pouring process into bottles or other storage containers. The integration of the cage 106 within the vacuum flask further enhances its usability by ensuring that milk or other liquids remain cool and secure throughout transport and storage.

FIG. 5D is a diagram illustrating a side view of the cage 106, in accordance with various aspects of the present disclosure. As shown in the example of FIG. 5D, the milk bag 208 may be pulled through a window 500 of one of the arms 128 of the cage 106. In this example, the user is using their hand to extract the milk bag 208 from the cage 106. The window 500, defined on the arm 128, allows the milk bag 208 to be pulled out with ease, offering convenient access to the contents of the bag 208. The design of the cage 106 ensures that the milk bag 208 remains securely in place until the user actively pulls it through the window 500. The flexibility of the arm 128 helps accommodate the milk bag 208 during the removal process, ensuring that the bag 208 can be easily accessed while maintaining its integrity. The bottom cover 104 of the cage 106 provides stability, keeping the cage 106 steady during the removal process

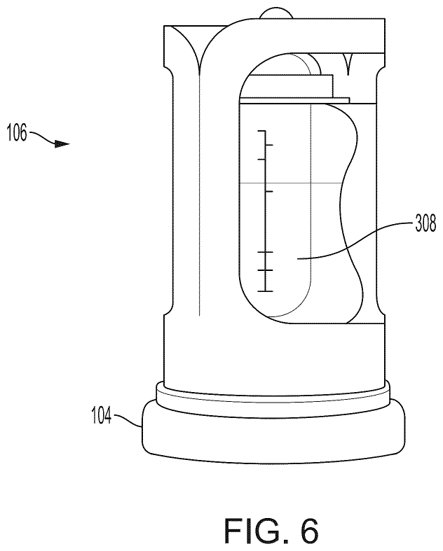

FIG. 6 is a diagram illustrating an example of the cage 106 and bottom cover 104 with an infant bottle 308, in accordance with various aspects of the present disclosure. As shown in the example of FIG. 6, the cage 106 retains the infant bottle 308 in position, while avoiding the need to set the infant bottle 308 down on a possibly dirty or contaminated surface. While not shown, it would be recognized that one or more pucks may be provided in the cage 106 with the infant bottle 308 to provide a cooling effect while the vacuum flask 100 is being used. The one or more pucks may be an example of the puck 114 described with reference to FIGS. 1 and 2B.

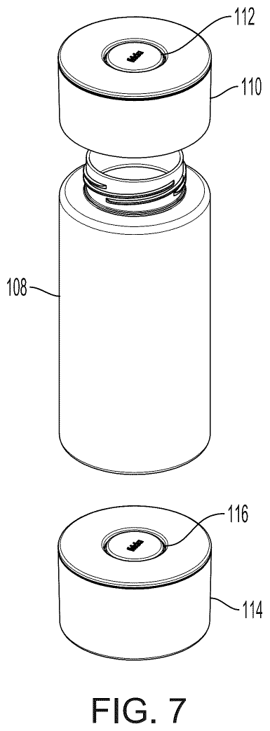

FIG. 7 illustrates an example of the vessel 108, the lid, 110, and the puck 114, in accordance with various aspects of the present disclosure. It would be understood that the vessel 108 may be provided with other shapes and geometries. The lid 110 and the puck 114 are configured to receive liquids such as water or another phase change material. The frozen water or phase change material in the lid 110 and the puck 114 will cool the liquid stored in a vessel 108 or another container. Together, these components maintain the liquid at a desired temperature, such as less than or equal to 59° F., for a period of time, while the vacuum flask 100 insulates the vessel 108 and its contents from the outside environment to maintain the temperature.

In another aspect, the lid 110 and/or the puck 114 may be pre-filled with a freezable liquid, such as water, and other components to lower the freezing point of the liquid, such as propylene glycol. The lid 110 and/or puck 114 may be cooled by placing them in a freezer or refrigerator prior to use, and the lid 110 and/or the puck 114 may be included in the vacuum flask 100 when it is ready to use for transporting or storing the desired liquid. It would also be appreciated that the height of the vessel 108 relative to the cage 106 and the entire vacuum flask 100, may be varied without departing from the aspects of the present disclosure. For example, the top of the arms 128, 130 may be about the same height as the top of the lid 110 when the puck 114, vessel 108, and lid 110 are disposed within the cage 106. Alternatively, the top of the arms 128, 130 may be about half of the height of the puck 114, vessel 108, and lid 110. The total height of the puck 114, vessel 108, and lid 110 may be slightly less than the distance between the bottom of the cage 106 and the internal top of the outer shell 102, so that lateral movement of the vessel 108 within the vacuum flask 100 is minimized.

As discussed, various aspects of the present disclosure are directed to a vacuum-insulated flask for storing and cooling liquids, particularly milk or breast milk, for extended periods. The flask integrates an innovative internal structure (e.g., a cage 106 described with reference to at least FIG. 1) that accommodates various storage containers while ensuring secure positioning and enhanced cooling efficiency. The vacuum flask consists of an outer shell with a cylindrical structure, constructed from stainless steel or plastic, featuring a vacuum-sealed inner wall to minimize heat transfer. Inside the outer shell, a removable cage is designed to securely hold different types of containers, such as an infant bottle, a milk storage bag, or a dedicated vessel. A bottom cover attaches to the cage, enclosing the internal volume while providing structural stability and insulation. In some examples, a vessel, such as the vessel 108 described with reference to at least FIG. 1, may include a cooling lid containing a freezable liquid, which, when frozen, helps maintain a low temperature for the liquid stored within the vessel. A cooling puck, positioned at the base of the cage, further enhances cooling by providing an additional cold source. The vacuum flask also features a handle assembly attached to the upper portion for easy portability.

The cooling system of the flask relies on multiple components working together to maintain the desired temperature. As discussed, the vessel's lid is designed to hold a freezable liquid that cools the stored liquid from the top, while the cooling puck at the bottom provides cooling from below. The vacuum-insulated outer shell significantly reduces heat exchange with the external environment, preserving the internal temperature for extended periods. Multiple cooling pucks can be used simultaneously to prolong the cooling effect or optimize temperature distribution.

As discussed, the vacuum flask accommodates different types of liquid storage containers. For milk storage bags, the cage features flexible arms with slits that securely hold the edges of the bag. This design keeps the bag open for easy filling, minimizing spills and contamination risks. The cage can also securely hold an infant bottle, preventing unnecessary movement while ensuring uniform cooling. Additionally, a custom-designed vessel may be used for direct liquid storage within the flask. The components are designed for easy assembly and use. The cage slides into the outer shell, aligning with internal threading or a securing mechanism. The bottom cover attaches to the cage, enclosing the internal storage space. A pivotable handle assembly is integrated for convenient carrying, and an anti-slip pad on the bottom cover enhances stability when placed on a surface. Before use, the vessel's lid and the cooling puck can be frozen separately, ensuring that milk or other liquids remain at a safe temperature throughout transport and storage.

In some examples, the vessel lid and cooling puck may contain alternative freezable substances, such as solutions with a lower freezing point to extend the cooling duration. In some examples, the cage structure may include multiple compartments, allowing the simultaneous storage of different liquids or multiple milk bags. The handle design can vary, including rigid handles, flexible straps, or detachable carrying loops. The attachment mechanism between the outer shell and the cage may employ different securing methods, such as a friction fit or a quick-locking mechanism. Additionally, the outer shell may be constructed from lightweight polymers for travel applications or heavy-duty stainless steel for enhanced durability.

As discussed, the vacuum flask is designed to ensure that the temperature of the contents is preserved for an extended period, even under varying environmental conditions. The vacuum-sealed space between the inner and outer walls of the flask is critical for preventing heat transfer. The inner wall may be made of a highly conductive material, such as stainless steel or glass, while the outer wall can be constructed from more lightweight materials, such as plastic, which helps reduce the overall weight of the flask. This dual-layer construction not only offers effective insulation but also enhances the flask's durability, ensuring it can withstand regular use without compromising performance. In some examples, the flask may include additional insulation features, such as thermal wraps or additional air pockets between the layers of the outer shell, to further reduce heat exchange.

As discussed, the flask is not limited to storing a milk bag or a designated vessel. For example, while the flask may store one or more milk storage bags, bottles, and/or custom-designed vessels, it could also be used to store other liquid-containing items, such as juice boxes or water bottles. The flask's customizable internal space allows for easy adaptation to various storage needs.

To enhance user experience, the vacuum flask may also include a system for indicating the temperature of the contents. For example, the flask could feature an integrated thermometer or a smart sensor system that provides real-time information about the temperature of the liquid inside. This feature would be especially beneficial for ensuring that milk or other temperature-sensitive liquids remain at the correct storage temperature. The information could be displayed via a small, integrated digital screen or transmitted to a mobile app, offering users convenience and peace of mind regarding the safety of their stored liquids.

In some examples, the vacuum flask may incorporate a more advanced cooling mechanism, such as a phase change material (PCM) integrated within the vessel or the cooling puck. PCMs have the ability to absorb or release heat as they change phases, offering a more efficient and longer-lasting cooling effect than traditional methods. This could extend the cooling period, making the flask ideal for longer trips or outdoor excursions where access to refrigeration may be limited.

Finally, the vacuum flask can be made available in a range of sizes and configurations to meet different user needs. For example, a larger version of the flask could be designed for extended trips or families, while a smaller version could be tailored for single-use or personal storage. Customizable compartments or detachable components could be included in some embodiments, allowing users to personalize the flask's storage layout based on specific needs, such as carrying multiple milk bags or different beverage containers simultaneously. These additional features ensure that the vacuum flask can be used in a wide range of scenarios, offering both practicality and flexibility for diverse users.

In some examples, the cage structure of the vacuum flask may physically separate the cooling elements, such as the ice-filled puck or lid, from the milk storage containers. This separation enables users to maintain individual milk portions from separate pumping sessions without the risk of cross-contamination or unintentional mixing. By isolating each milk bag from direct contact with the ice, the system preserves the integrity of the contents while still achieving effective cooling through proximity and convection within the insulated environment.

The cage may include various securing mechanisms to retain flexible milk storage bags in an upright and open configuration. While certain implementations feature vertical slits between the arms of the cage, other designs may employ slots, clips, hooks, or other friction-based or geometric restraints to secure the sides of a flexible milk bag. These alternative securing features may be formed as part of the cage wall, integrated into extensions of the arms, or applied as modular attachments. In each case, the securing mechanism provides a means to stabilize the milk bag for filling, pouring, or storage.

The cage also supports the vertical orientation of one or more milk storage bags during use. This configuration contrasts with traditional insulated containers that require milk bags to be rolled up and inserted sideways, which can lead to awkward positioning and inconsistent cooling. In various aspects of the present disclosure, milk bags are positioned upright within the cylindrical cavity of the cage, resulting in a more organized internal layout and more uniform exposure to cooling elements.

Beyond holding a single liquid container, the cage may receive a variety of components, including multiple ice pucks, milk bags, or other temperature-sensitive items. For example, a user may insert a combination of one or more milk bags and additional cooling pucks to extend the overall cooling period or to accommodate varying storage needs. This modular approach allows users to configure the interior of the vacuum flask according to specific use cases or storage preferences.

The cage also supports a vertically stacked arrangement of components, with the cage walls and the adjacent elements providing mutual structural support. The cylindrical shape and internal dimensions of the cage prevent excessive shifting of the contents, even during transport. This stackable configuration contributes to thermal efficiency by minimizing gaps between items and enhancing physical stability within the vacuum flask.

In some examples, the cage is manufactured from a flexible material, such as high-impact polystyrene or polypropylene, which allows the arms of the cage to flex during use. This flexibility enables the user to pinch the arms together to secure the sides of a milk bag, or to accommodate the insertion of components that may slightly exceed the nominal internal dimensions of the cage. The material compliance also reduces stress on the container walls and promotes user comfort during handling.

Finally, in some examples, the lid or cap of the milk vessel, particularly one containing a cooling substance, has a diameter that is slightly larger than the body of the vessel. When the vessel is inserted into the cage, the enlarged lid interfaces with the inner surface of the cage, acting as a stabilizing structure. This geometric interaction reduces lateral motion of the vessel during travel and helps protect the container from damage due to impact or vibration. This design consideration contributes to the system's overall robustness and reliability, especially in portable use scenarios.

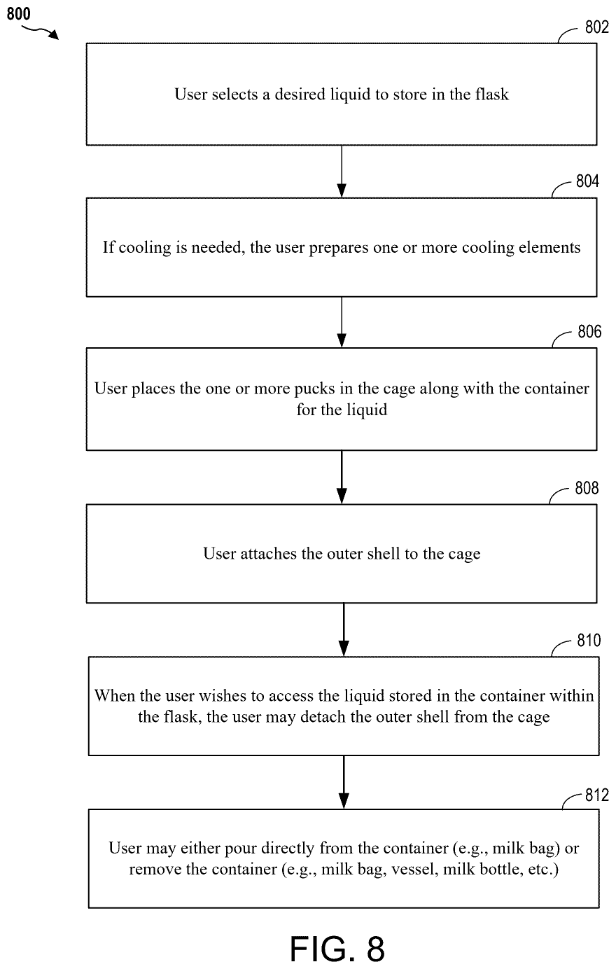

FIG. 8 is a flow diagram illustrating a process 800 of using a vacuum flask, in accordance with various aspects of the present disclosure. The vacuum flask may be an example of the vacuum flask 100 described with reference to FIG. 1. As shown in the example of FIG. 8, the process 800 begins at block 802, where the user selects a desired liquid to store in the flask, such as milk or any other beverage. In some examples, the user may select to store the liquid in a container, such as a dedicated vessel, an infant bottle, a milk storage bag, or another type of container, depending on the intended use. The selected container may be placed inside a cage of the vacuum flask. The cage may include a pair of flexible arms designed to securely hold the container in place, preventing excessive movement or spillage. The user can insert the container through the top of the cage, which allows for minimal disturbance of the contents.

At block 804, if cooling is needed, the user prepares one or more cooling elements. For example, the user may fill the lid of the vessel with a freezable liquid or ensure that one or more pucks are filled with a freezable liquid, such as water. The lid and/or the one or more pucks may also be pre-filled with the freezable liquid by the manufacturer. Once the liquid is in place, the lid is sealed onto the vessel and/or the one or more pucks are inserted into the cage below the vessel. The cooling puck and lid together provide a dual cooling effect: the puck cools from the bottom, and the freezable liquid in the lid cools the contents from the top. This ensures that the liquid in the vessel stays cool for an extended period.

At block 806, the user places the one or more pucks in the cage along with the container for the liquid. At block 808, the user attaches the outer shell to the cage. The cage slides into the outer shell and is secured in place using threads, a friction fit, or other securing mechanisms. Once attached, the vacuum flask's internal cavity is sealed, maintaining the temperature of the contents. The vacuum between the inner and outer walls of the flask reduces heat transfer, keeping the liquid cool for hours.

At block 810, when the user wishes to access the liquid stored in the container within the flask, the user may detach the outer shell from the cage. Then, at block 812, the user may either pour directly from the container (e.g., milk bag) or remove the container (e.g., milk bag, vessel, milk bottle, etc.). As discussed, in some examples, the flexible arms of the cage allow the user to easily open the milk bag by squeezing the arms together, enabling controlled pouring. Alternatively, the milk bag can be pulled out through the window of an arm, as described above. This step enhances convenience by allowing the user to access the liquid without disturbing the other components inside the flask.

In some examples, the cooling elements could include reusable gel packs or other materials with high thermal mass to replace or supplement the liquid-filled puck and lid. The outer shell may also be designed with a variety of materials or insulation types, such as thicker walls for enhanced cooling duration or lightweight options for portability. The handle design could also vary, offering options for a retractable handle, a detachable strap for hands-free carrying, or an ergonomic design for added comfort. The vacuum flask's cage could be configured to hold additional items, such as multiple milk bags or a combination of bottles and bags, depending on the specific needs of the user.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, the phrase “and/or” is intended to be interpreted to encompass all combinations of the listed elements. For example, the expression “A, B, and/or C” should be understood to mean at least one of A, B, or C, and includes any combination thereof, such as A alone, B alone, C alone, A and B together, A and C together, B and C together, or A, B, and C together. Unless explicitly stated otherwise, the use of “and/or” does not require the presence of all listed elements simultaneously, and is intended to provide flexibility in interpreting the scope of the features recited.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A vacuum flask, comprising:
an outer shell with an opening;
a cage for receiving a container, the cage being removably coupled with the outer shell; and
a bottom cover coupled to the cage, the bottom cover and outer shell enclosing the internal cage in accordance with the cage being coupled with the outer shell.

2. The vacuum flask of claim 1, wherein the cage is cylindrical.

3. The vacuum flask of claim 2, wherein the cage includes two arms extending vertically from a base portion of the cage.

4. The vacuum flask of claim 3, wherein:
the base portion includes threads for coupling with female threads of the outer shell; and
the base portion comprises polystyrene foam.

5. The vacuum flask of claim 3, wherein the cage includes two vertical slits formed between the two arms, and the two vertical slits are capable of securing respective portions of one or more milk bags.

6. The vacuum flask of claim 5, wherein the two vertical slits support one or more milk bags in a vertical position.

7. The vacuum flask of claim 3, wherein:
the two arms stabilize one or more items placed between the two arms;
the one or more items including one or more milk bags, one or more cooling pucks, and/or one or more containers.

8. The vacuum flask of claim 3, wherein the cage supports a group of items vertically stacked between the two arms.

9. The vacuum flask of claim 3, wherein the two arms are flexible.

10. The vacuum flask of claim 1, wherein the outer shell includes an outer wall and an inner wall, wherein a space between the inner wall and outer wall is vacuum sealed.

11. The vacuum flask of claim 1, wherein the container is a vessel for holding a liquid, an infant bottle, or one or more milk bags.

12. The vacuum flask of claim 11, wherein the vessel is removably coupled to a lid, and the lid comprises a phase changing substance.

13. The vacuum flask of claim 1, further comprising one or more pucks comprising a phase changing substance.

14. The vacuum flask of claim 12, wherein each of the one or more pucks and the container are disposed within the cage.

15. The vacuum flask of claim 1, wherein the liquid is milk.

16. The vacuum flask of claim 1, wherein the outer shell includes a handle.

17. A vacuum flask, comprising:
an outer shell having a cylindrical shape with a first and second end, and the second end includes an opening;
a bottom cover configured to cover the opening of the outer shell;
a cage coupled to the bottom cover, the cage being received within the outer shell via the opening;
a vessel for receiving a liquid, the vessel being disposed in the cage; and
a lid configured to couple to the vessel, the lid comprising a freezable liquid.

18. The vacuum flask of claim 17, wherein the cage is cylindrical.

19. The vacuum flask of claim 18, wherein the cage includes a pair of arms extending vertically from a base portion of the cage.

20. The vacuum flask of claim 19, wherein:
the base portion includes threads for coupling with female threads of the outer shell; and
the base portion comprises expandable foam or expanded foam.

21. The vacuum flask of claim 19, wherein a liquid storage bag is held between the pair of arms.

22. The vacuum flask of claim 19, wherein each arm includes an opening for accessing an item stored within the cage.

23. The vacuum flask of claim 17, further comprising one or more pucks comprising a freezable liquid, wherein the one or more pucks and the vessel are disposed within the cage.

24. The vacuum flask of claim 17, wherein the bottom cover includes an anti-slip pad.

25. The vacuum flask of claim 17, wherein the lid stabilizes the vessel in the cage.
